(19) United States
(12) Patent Application Publication
(10) Pub. No.: US 2014/0238249 A1
(43) Pub. Date: Aug. 28, 2014

(54) MACHINE FOR PREPARING A BEVERAGE

(71) Applicants: Alain Mariller, Le Mont-Pelerin (CH); Jean-Paul Gaillard, Cully (CH)

(72) Inventors: Alain Mariller, Le Mont-Pelerin (CH); Jean-Paul Gaillard, Cully (CH)

(73) Assignee: ETHICAL COFFEE COMPANY SA, Fribourg (CH)

(21) Appl. No.: 14/112,593

(22) PCT Filed: Apr. 13, 2012
(86) PCT No.: PCT/IB2012/051814

§ 371 Date: Dec. 3, 2013

(30) Foreign Application Priority Data
Apr. 21, 2011 (IB) PCT/IB2011/051756

(51) Int. Cl. A47J 31/40

(52) U.S. Cl. CPC A47J 31/407
USPC 99/295

(57) ABSTRACT

The invention relates to an extraction machine using capsules inserted into a capsule housing, including rails that make it possible to guide the inlet of a capsule into the machine, hold the capsule in an axially aligned position, release the capsule during an axial movement in order to enter an extraction position, retain the capsule when the latter leaves the extraction position, and guide the exit of the released capsule.

### FIELD OF THE INVENTION

The present invention is situated in the field of the preparation of beverages, e.g. coffee-based, by extraction of a concentrated dose, e.g. of ground coffee, contained in a capsule. It relates more particularly to the devices using such doses, in particular to the extraction machines such as coffee machines.

### PRIOR ART

Capsules and machines functioning according to the above-mentioned principle have existed for many decades.

The patents U.S. Pat. No. 2,899,886, U.S. Pat. No. 2,968,560, U.S. Pat. No. 3,403,617 and U.S. Pat. No. 3,607,297 describe devices in which the capsule is initially perforated in several places, then passed through by water under pressure.

The capsule described in the patent CH 605 293 or in the patent EP 0 242 556 B1 comprises a membrane in its lower part. Water under pressure is initially introduced into the upper part of the capsule, which brings about a swelling of the capsule, principally at the level of the membrane. Starting from a certain pressure, the membrane tears, thus permitting the flow of a water-coffee mixture.

Other capsules provided with a membrane are described in the following patent documents: EP 0 468 079 A, EP 0 806 373 A, EP 0 554 469 A.

By way of example, the publication WO 2005/004683, the content of which is incorporated by reference in the present application, describes a device for the extraction of a capsule. As described in a detailed manner in this publication, one of the problems with which one is confronted in such devices is the positioning of the capsule in the device and the closure thereof around the capsule to implement the extraction.

It is sought in particular to make possible a positioning which is very simple for the user and is secure for the machine so as to implement the extraction under optimum conditions.

Numerous publications of the prior art have been identified in WO 2005/004683 and reference is made to these documents for the detailed exposition of the prior art (see pages 1-3 of WO 2005/004683).

This prior art WO 2005/004683 proposes several modes of execution for implementing the extraction system. The principle of this prior art is as follows: it concerns causing a capsule to pass from an intermediate position to an extraction position, the capsule being retained in a first position (designated as intermediate), it passes into an extraction position, and after the extraction the capsule is released naturally under the simple effect of gravity, for example it falls into a recovery means and a new capsule can be introduced into the machine.

The fixed part comprises a guide body for the movement in translation of the mobile part towards the fixed part. The guide body can, for example, be oriented substantially horizontally to guide the mobile part along a horizontal movement. This guide body is constituted for example by at least two rails, preferably four guide rails. The device according to the invention makes possible an extraction by horizontal water injection. The mobile part is preferably substantially cylindrical.

In the device according to WO 2005/004683, the part for introduction and for positioning of the capsule is disposed in front and perpendicularly to the guide body and includes at least one guide means. Preferably, it includes two guide means. These means can be of any kind, for example, in the case of the extraction of a capsule according to the patent EP 512′148 the concern is with introduction rails permitting the engagement of the collar of the capsule.

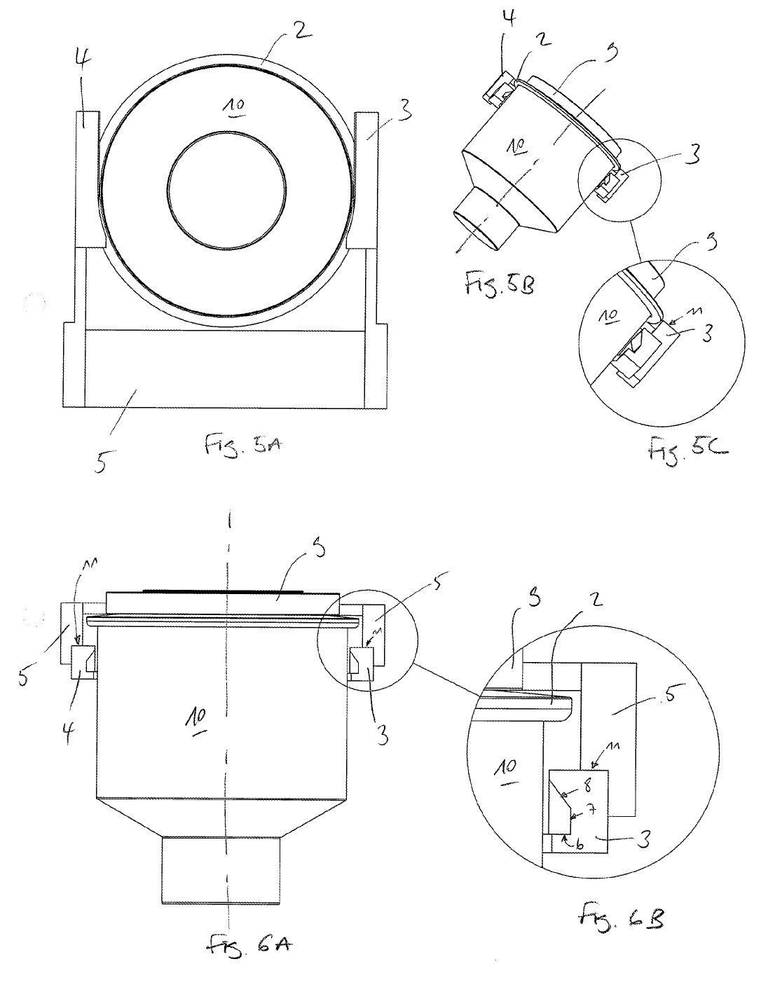

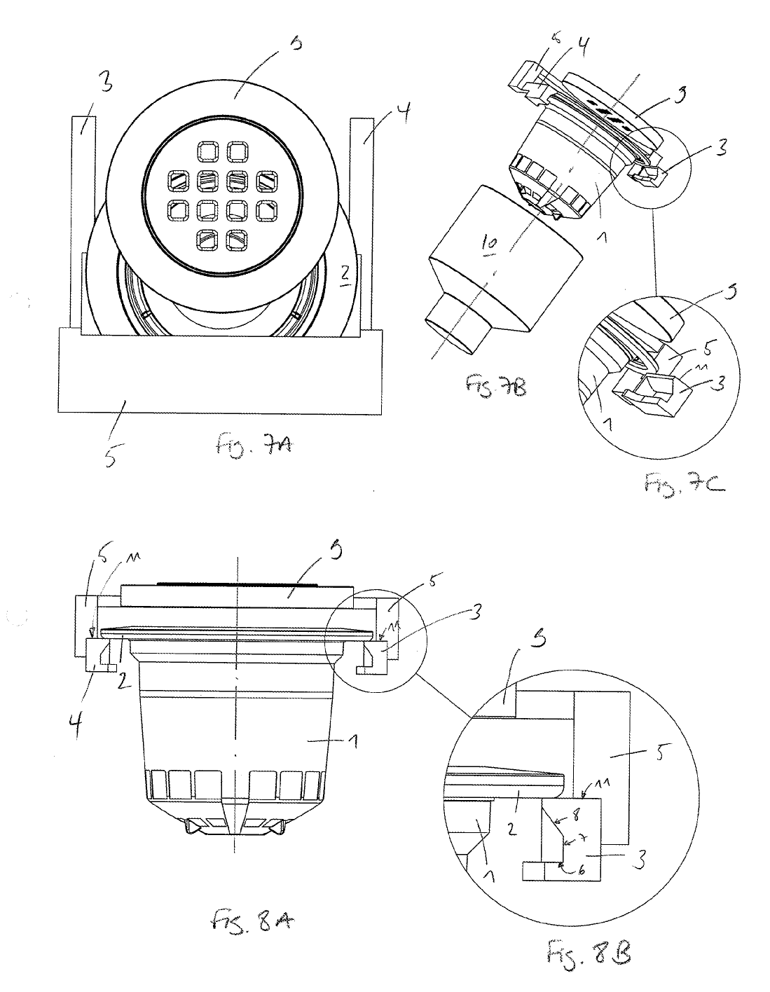

In WO 2005/004683, a first mode of execution which is illustrated in particular in FIGS. 5-6, a second mode is illustrated in FIGS. 7-10 and a third mode is illustrated in FIGS. 11-13.

In a more detailed manner, in the first mode, the device includes stop means of the capsule. These stop means are configured to retain the capsule in intermediate position when the capsule is introduced into the part for introduction and positioning. These stop means retain the capsule along an offset or inclined axis with respect to the axis of the capsule in extraction position in the housing, the extraction position corresponding to the position in which the mobile part is closed against the fixed part by holding the capsule.

To pass from the intermediate position to the extraction position, two solutions exit according to WO 2005/004683.

A first solution consists in holding the capsule in intermediate position in an offset manner with respect to the axis of the capsule in extraction position, for example, so that the mobile part in its movement acts on the capsule in order to lower it and push it along the axis of the said mobile part in its extraction position. The capsule can be offset along its recentring axis (or extraction axis), for example parallel thereto, or can be inclined with respect to its recentring axis by a certain angle, preferably a small angle less than 30 degrees. Such a solution makes it possible to avoid any mechanical complexity and uses a minimum of mobile parts. In fact, the capsule can be simply held in intermediate position by static stop means and it is the mobile part which undertakes to displace the capsule during its displacement towards the fixed part and then comes to position it in extraction position, by bringing the axis of the capsule into its extraction position.

In a first preferred embodiment, the mobile part is thus configured to force the passage of the capsule beyond the stop means during the passage of the capsule from its intermediate position to its extraction position. Thus, when the mobile part drives the capsule, the latter being positioned along an offset or inclined axis, the capsule is re-established by force in the displacement axis of the mobile part corresponding to the axis of the capsule in extraction position, which forces the capsule to pass beyond the stop means. Once the stop means have been passed by the capsule, the latter is placed in extraction position by one of the parts at least closing against the other and applying the capsule against the extraction part. Once the re-opening of the two parts has occurred, the capsule is no longer held by the stop means and it is therefore able to be released.

A second possibility is that the mobile part simply pushes the capsule in its displacement axis in its extraction position.

In order to implement this second possibility, the device of WO 2005/004683 proposes stop means which are configured to retain the capsule in intermediate position along an axis substantially coaxial with the axis of the housing, but the mobile part acts on the opening of the stop means to separate them actively and to permit the passage of the capsule from its intermediate position to its extraction position.

In this mode, the guide means are pivoting and form or include stop means arranged to lock the capsule in intermediate position when the mobile part is in open position and to unlock the capsule when the mobile part is in closed position. These guide means are actuated in locking and unlocking position by an actuating lever, rotatably mounted and disposed on the exterior of the mobile part: this lever, by the displacement of the mobile part, places the guide means in locking or unlocking position.

In a final embodiment of the device according to the invention described in WO 2005/004683, the latter includes in front of the guide body a retractable stop, disposed beneath the mobile part. This retractable stop is also actuated by the displacement of the mobile part: it makes it possible to hold the capsule in position when the mobile part is in open position.

As will be understood, WO 2005/004683 proposes several distinct solutions to permit the temporary holding of the capsule in an intermediate position, its displacement in an extraction position and its release after the extraction, these solutions all having their complexity, a potential source of problems and malfunctions.

### GENERAL DISCLOSURE OF THE INVENTION

One of the objectives of the present invention aims to improve the general functioning of the machine.

More precisely, an aim of the invention is to improve the known systems, in particular the devices described in WO 2005/004683 by proposing means which are simple, reliable and easy to implement.

As in the prior art cited above, the present invention applies to all types of capsules, and in particular to the capsules having an edge, such as a collar, which cooperates with guide means of the machine, the said capsules containing any type of product as described in WO 2005/004683. The present invention can be used in the conventional extraction machines, typically those described in this same prior art and the description and the principles of WO 2005/004683 apply in a corresponding manner here.

An idea of the present invention is to make possible the passage of the capsule from its intermediate position (after its introduction into the machine by the user) in which its axis is not offset as in WO 2005/004683 to its extraction position but without using auxiliary actuating means for separating the guide means or for forming a stop as in the second and third mode of execution of WO 2005/004683.

The invention is realized in particular by the use of flexible guide means which have a particular profile: these original characteristics permit both the holding of the capsule in its intermediate position and its passage to the extraction position without the necessity for or direct action of additional means as taught in WO 2005/004683.

Alternatively, according to another mode of execution, the guide means are rigid, but it is the capsule which deforms during its passage from the intermediate position to its extraction position.

Thus, a system is obtained which is much more simple and reliable, easier to manufacture and less expensive than those which are known, in particular from WO 2005/004683.

The different modes of execution of the invention are defined in the attached claims.

### DETAILED DESCRIPTION OF THE INVENTION

The present invention will be better understood by the description of modes of execution thereof and of figures which show:

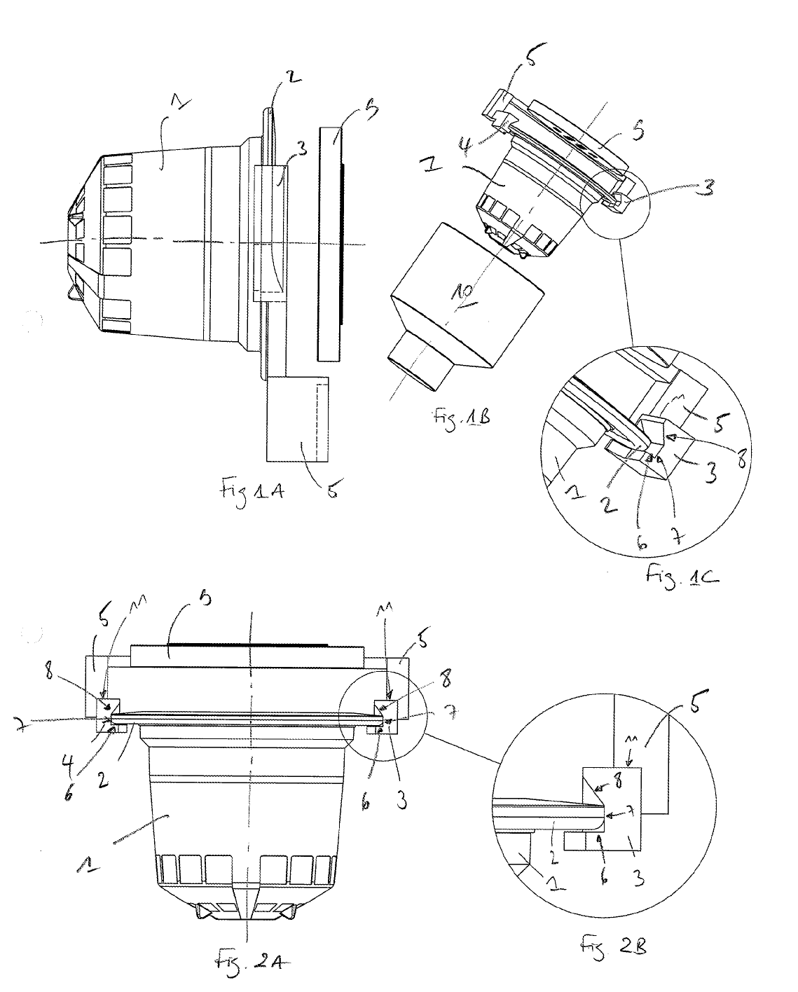

FIG. 1A illustrates a side view of the invention.

FIG. 1B illustrates a top view and in perspective of the invention in a first position.

FIG. 1C illustrates a detail of FIG. 1B.

FIG. 2A illustrates a top view of the invention in a first position.

FIG. 2B illustrates a detail of FIG. 2A.

FIG. 3A illustrates a front view of the invention.

FIG. 3B illustrates a top view and in perspective of the invention in a second position.

FIG. 3C illustrates a detail of FIG. 3B.

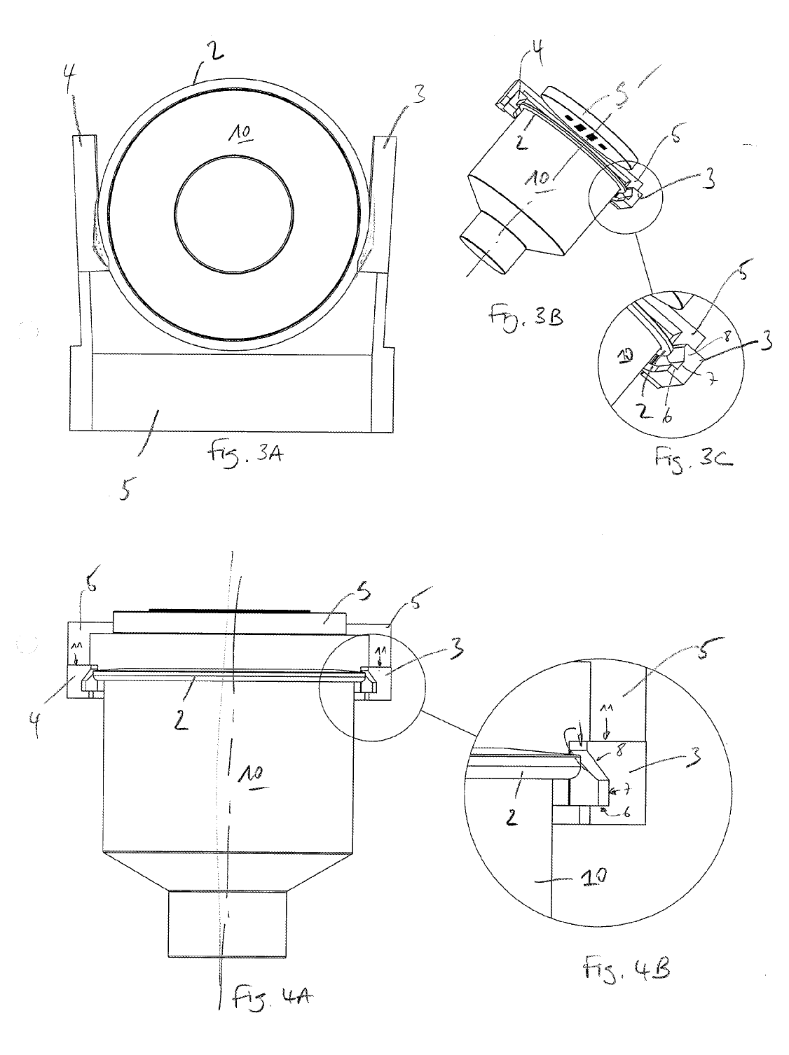

FIG. 4A illustrates a top view of the invention in a second position.

FIG. 4B illustrates a detail of FIG. 4A.

FIG. 5A illustrates a front view of the invention in a third position.

FIG. 5B illustrates a top view and in perspective of the invention in a third position.

FIG. 5C illustrates a detail of FIG. 5B.

FIG. 6A illustrates a top view of the invention in a third position.

FIG. 6B illustrates a detail of FIG. 6A.

FIG. 7A illustrates a front view of the invention in a fourth position.

FIG. 7B illustrates a top view and in perspective of the invention in a fourth position.

FIG. 7C illustrates a detail of FIG. 7B.

FIG. 8A illustrates a top view of the invention in a fourth position.

FIG. 8B illustrates a detail of FIG. 8A.

In the following description, the similar and/or identical elements in the different figures are identified by means of the same reference numbers.

FIGS. 1A-1C and 2A-2B illustrate the system according to the invention in a first position. Thus, a capsule 1 with a rim 2 (the said capsule being known in the prior art, see the description above) is introduced in rails 3 and 4 held by a rail holder 5. The capsule, in a manner known for example from WO 2005/004683, is introduced from the top (corresponding to the top of FIG. 1A), the axis of the capsule 1 being approximately horizontal. It descends, by gravity, its collar 2 sliding in the rails 3, 4. The rails 3 and 4 have an asymmetrical interior profile with a bottom 7 and a perpendicular side 6 in an “L” shape, and a second side 8 which is non-perpendicular but forming an angle with respect to the bottom 7, as an inclined plane, as is readily seen in FIGS. 1C, 2A and 2B in particular.

The bottom of the rails terminates in a “V” shape, as will be understood further below in the description forming stop means so as to hold the capsule 1 in a specific position after its introduction in the machine, i.e. in the rails 3, in the intermediate position as discussed in WO 2005/004683.

In FIGS. 1A, 1B and 2A, in addition the extraction plate 9 is illustrated, against which the capsule 1 will come to rest during the extraction procedure, and the capsule housing 10 which will surround and entrain the capsule 1 for the extraction. This procedure is similar to that which is known from the prior art, for example disclosed in WO 2005/004683.

FIGS. 3A-3C and 4A-4B show the system according to the invention in a second position. In this position, the capsule 1 is moved axially in the direction of the plate 9 by the capsule housing 10, with respect to the preceding figures. It can firstly be seen in FIG. 3A in which the rails 3 and 4 are separated from one another owing to the movement of the capsule 1, this movement being visible in FIGS. 3B, 3C, 4A and 4B. In fact, in these figures, it is seen that the collar 2 of the capsule 1 has moved along the inclined plane 8 (by comparing for example FIGS. 2B and 4B).

This movement is axial and caused by the axial movement of the capsule housing 10 according to the known principles.

Thus, the movement of the collar 2 on the inclined plane 8 tends to separate the two rails as illustrated in FIG. 3A.

FIGS. 5A to 5C and 6A, 6B show the system in an extraction position. In the latter, the capsule 1 is placed flat against the plate 9 and the capsule housing hermetically closes the system to permit the extraction according to the known method.

As can be seen in FIGS. 5B, 5C, 6A, 6B, the collar 2 has passed the rails 3, 4 and is situated flat against the plate 9 (see in particular the detail of FIG. 6B). The rails 3, 4 have returned into a position approximately perpendicular to the rail holder 5 (compare FIGS. 3A and 5A).

In FIGS. 7A to 7C and 8A, 8B the system has been illustrated in an ejection position of the capsule 1, for example after the extraction.

The housing 10 is withdrawn and the capsule 1 moves away from the plate 9, entrained by the housing 10 until the collar 2 of the capsule arrives at stop 11 against the rails 3, 4 (illustrated in detail in FIGS. 8A and 8B). In this case, the rails 3, 4 do not separate but retain the capsule 1 and therefore permit its extraction from the housing 10 which continues its movement of axial withdrawal.

Once the housing 10 is entirely withdrawn, the capsule can fall into a recuperator (not illustrated) by sliding along the rails 3 and 4, as represented in FIG. 7A.

As will be understood from the preceding description and the figures, the slides according to the invention have several roles: on the one hand, to retain the capsule in aligned axial position to permit the supply of the housing 10; then release by separation to permit the axial movement of the capsule and of the housing to bring them into extraction position; and finally retaining on stop form of the capsule 1 to cause it to exit from the housing 10 after the extraction.

In another mode, provision can be made that the guide means, namely the rails for example which are described above, are rigid or deform with difficulty or not at all, such that during the passage of the capsule, it is rather the capsule, for example the collar of the capsule, which deforms instead of the rails which separate as described above, a deformation of the two (i.e. separation of the rails and deformation of the capsule) also being able to be envisaged. The general principle of the present invention does not change in the sense that the capsule is not inclined as in the prior art cited above, or its axis is not offset with respect to that of the capsule housing, nor are there auxiliary retaining means as described in the prior art.

The capsule and/or the collar which deforms (at least partially) during the passage, can undergo an elastic or plastic deformation. Preferably, the rails, if they deform, undergo an elastic deformation. The stop effect generated by the rails during the withdrawal of the housing which permits the retaining of the capsule which is used can possibly be slightly or greatly lessened as a function of the deformation of the capsule (elastic or plastic, great or small) and in such a case it can be advisable to use additional means to assist the extraction of the capsule which is used. Nevertheless, if the deformations are small, the stop effect will be realized notwithstanding.

The (plastic) deformation of the capsule and/or collar is preferably small so as not to risk calling into question the tightness during the extraction. Of course, it can be useful and/or necessary to provide supplementary means to improve the tightness.

The rails can be of any material suited to the use according to the invention. For example, they can be of plastic, synthetic, material etc.

The invention is, of course, not limited to the modes of execution described by way of illustration and being non-restrictive, and variations are possible within the scope of the claimed protection. The described modes of execution can also be combined freely, depending on the circumstances.

One can, in particular, have recourse to equivalent means to those described.

### REFERENCE NUMBERS USED IN THE FIGURES

1. capsule
2. collar of capsule
3. rail
4. rail
5. rail holder
6. first wall of rail
7. bottom of rail
8. second wall of rail, inclined plane
9. extraction plate
10. capsule housing
11. rail stop

1. Rails for extraction machine using capsules inserted into a capsule housing, the said rails making it possible to guide the inlet of a capsule into the machine, hold the capsule in an axially aligned position, release the capsule during an axial movement in order to enter an extraction position, retain the capsule when the latter leaves the extraction position, and guide the exit of the released capsule.

2. The rails according to claim 1, the said rails being flexible in order to deform so as to permit the passage of the capsule from the axially aligned position to the extraction position.

3. The rails according to claim 1, the said rails being slightly or non-flexible, the passage of the capsule from the axially aligned position to the extraction position deforming the capsule and/or a part thereof.

4. The rails according to claim 2, the said deformations being elastic and/or plastic.

5. The rails according to claim 1, including at least a first wall, a bottom, a second wall in the form of an inclined plane and a face forming a stop.

6. The rails according to claim 1, including a rail holder on which they are mounted, or forming a single piece.

7. The rails according to claim 1, formed of synthetic or plastic material.

8. An extraction machine including at least rails such as defined in claim 1.

9. The machine according to claim 8, in combination with at least one capsule, for example a coffee capsule.
